(19) United States
(12) Patent Application Publication
(10) Pub. No.: US 2025/0299064 A1
(43) Pub. Date: Sep. 25, 2025

(54) CASCADED PRIVACY COLLABORATIVE LEARNING WITH ENHANCED PERFORMANCE

(71) Applicant: HEWLETT PACKARD ENTERPRISE DEVELOPMENT LP, Spring, TX (US)

(72) Inventors: Radhakrishna Jella, Bangalore (IN); Suresh Soundararajan, Bangalore (IN); Milind B. Desai, Bangalore (IN)

(21) Appl. No.: 18/664,911

(22) Filed: May 15, 2024

(30) Foreign Application Priority Data
Mar. 21, 2024 (IN) 202441021934

(51) Int. Cl. G06N 3/098

(52) U.S. Cl. CPC G06N 3/098

(57) ABSTRACT

Systems and methods are provided for cascaded privacy decentralized learning. Examples herein provide network nodes that train local instance of a machine learning (ML) algorithm with local data over a plurality of training stages. Each network node determines local parameters at one or more iterations of training during each training stage and applies, during each training stage, an amount of differential privacy to respective local parameters. The amount of differential privacy applied during one training stage is less than an amount differential privacy applied during a preceding training stage. A leader node merges the local parameters from the network nodes and shares the merged parameters with the network nodes to provide common ML model.

### BACKGROUND

Machine learning (ML) generally involves a computer-implemented process that builds a model using sample data (e.g., training data) in order to make predictions or decisions without being explicitly programmed to do so. ML processes are used in a wide variety of applications, particularly where it is difficult or unfeasible to develop conventional algorithms to perform various computing tasks.

Collaborative learning (also known as federated learning) is a sub-field of ML in which multiple decentralized entities collaboratively train a common ML model using decentralized data held locally at each entity. These collaborative learning approaches stand in contrast to traditional centralized ML techniques where local datasets are uploaded to a centralized server, as well as in contrast to more classical decentralized approaches which often assume that local data samples are identically distributed.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates an example system for decentralized learning, according to an example implementation of the disclosure.

FIG. 2 illustrates a process that can be performed by the decentralized learning network in accordance with examples disclosed herein.

FIG. 3 illustrates example sub-operations that can be performed as part of the process of FIG. 2 in accordance with examples disclosed herein.

FIG. 4 is an example computing component that may be used to implement various features of multi-stage privacy decentralized learning in accordance with the implementations disclosed herein.

FIG. 5 is example of operations that may be performed by a multi-stage privacy decentralized learning system in accordance with the implementations disclosed herein.

FIG. 6 is an example computer system that may be used to implement various features of cascaded-privacy collaborative learning of the present disclosure.

The figures are not exhaustive and do not limit the present disclosure to the precise form disclosed.

### DETAILED DESCRIPTION

As alluded to above, collaborative learning (also referred to herein as federated learning) is a type of ML process that trains an ML model across multiple decentralized entities (e.g., devices or other computing component) holding local data samples. In some examples, the decentralized entities, which may be referred to as nodes, may not exchange their respective local data sets. This approach stands in contrast to traditional centralized ML techniques, where local datasets can be uploaded to one, centralized server. Collaborative learning can enable multiple entities to build a common, robust ML model without a need to share their local data, thus addressing several issues such as data privacy, data security, data access rights, and access to heterogeneous data. Collaborative learning finds applicability over a number of industries including but not limited to defense, telecommunications, Internet of Things (IoT), healthcare, social sciences, finance, pharmaceuticals, and so on.

In examples of collaborative learning, the multiple decentralized entities can use data locally available to each of the entities to learn local model parameters. For example, each of the decentralized entities can perform local training on local instances of an ML algorithm using locally held data samples to learn respective local parameters. These local parameters can be provided as weights and/or biases that can define a local instance of an ML model. The decentralized entities can share the learned local parameters to a merge leader entity, selected from the multiple decentralized entities, which derives global parameters by merging the shared local parameters. These global parameters represent the common ML model (also referred to herein as a global ML model). The global ML model can be distributed back to the decentralized entities by sharing the global parameters.

In some examples, the multiple decentralized entities can perform one or more additional iterations of training (each iteration can be referred to as a batch), i.e., applying local data to update the global ML model. For example, during a subsequent iteration, the decentralized entities can update respective local instances of the ML algorithm using the shared global parameters and retrain the updated local instances using respective local data samples. This retraining can provide updated local parameters. The updated local parameters can be shared with and merged by a merge leader entity, which may be the same or different entity as the previous merge leader entity, to generate updated global parameters. This iterative process can be repeated a number of times until a desired performance of the global ML model is achieved.

While collaborative learning can address some data privacy, data security, and data access concerns (collectively referred to as privacy concerns) that may arise out of sharing local data samples, other privacy concerns may still remain due to sharing local parameters. For example, a merge leader entity may be a bad actor or otherwise malicious entity that seeks to obtain local data associated with other entities. The malicious merge leader entity can utilize various techniques to reverse engineer local data of another entity from shared local parameters, thereby overcoming the privacy gained through the decentralized approach. As an example, a merge leader entity may obtain shared local parameters from an entity, as described above. The merge leader entity may use its local data samples as ground truth samples, which can be applied to the shared parameters to derive a particular set of local data samples. For example, with knowledge of how a the merge leader's local data impact (e.g., change) results of the ML model implemented using the shared local parameters, the merge leader entity can derive corresponding local data of an entity.

Accordingly, implementations of the present disclosure leverage differential privacy to secure privacy of local data in collaborative learning. Differential privacy provides a framework for ensuring privacy and confidentiality in data by introducing controlled bias, noise, or randomness into data (collectively referred to herein as differential privacy noise). Examples disclosed herein leverage differential privacy by applying differential privacy noise to local parameters prior to sharing the local parameters, thereby ensuring that the impact of particular local data on a global model is indistinguishable from the impact of any other local data. For example, upon determining local parameters at a particular decentralized entity, the particular decentralized entity perturbs its local parameters by applying a differential privacy noise to each local parameter. The amount or magnitude of differential privacy noise applied can be dependent on a desired level of privacy, where larger amounts or magnitudes provide increased privacy to each parameter. The perturbed local parameters can then be shared with a merge leader entity as differentially private local parameters. As a result, a malicious merge leader entity may not be able to reverse engineer specific local data from differentially private local parameters due to noise applied thereto. That is, any data derived from the differentially private local parameters would be likewise perturbed and, therefore, would not be representative of the actual local data.

However, challenges remain in leveraging differential privacy. For example, model performance is inversely proportional to the privacy gained through differential privacy. That is, for example, increasing a differential privacy budget (e.g., by increasing the amount or magnitude of differential privacy noise) results in decreased model performance due to the use of noisy or otherwise perturbed data samples for training. For example, a resulting global model may be less optimal (e.g., lower accuracy) due to training data that is less representative of ground truths. Thus, optimal performance may not be achievable when using differential privacy across an entire training. Additionally, computation costs in terms of resources and time to solution is proportional to the privacy gained through differential privacy. For example, training using differential privacy under certain conditions may take two times more than the amount of time to train without differential privacy. Thus, a trade-off exists between increased privacy and model performance metrics, as well as computation costs. As an illustrative example, training a simple neural network model applied to MNIST (Modified National Institute of Standards and Technology) dataset on 15 epochs without differential privacy may provide 97% accuracy and take 80 minutes, while training using differential privacy for the entire training may take 160 minutes and only provide 90% accuracy.

Accordingly, the present disclosure provides for a multi-stage collaborative learning approach, in which an amount of differential privacy applied during a stage of learning is less than that applied during a preceding stage of learning. As an illustrative example, differential privacy may be leveraged during a first stage and not applied during a final stage. For example, during the first stage, each decentralized entity determines its own respective local parameters by training a local instance of an ML algorithm using respective local data. Each decentralized entity perturbs respective local parameters to provide differentially private local parameters, for example, by applying differential privacy noise to their respective local parameters. The amount of differential privacy noise applied by each decentralized entity may be the same across the entities or may be varied, depending on the application and the desired degree of privacy for each respective entity. The differentially private local parameters can then be shared with a merge leader entity that merges (e.g., aggregates) the shared differentially private local parameters to generate differentially private global parameters which define an intermediate global ML model.

The above process can be repeated for a number of iterations (or epochs) until an iteration of the intermediate global ML model, derived using differentially private local parameters, satisfies a privacy-centric performance threshold. For example, a merge leader entity may verify that a performance metric of the intermediate global ML model meets or exceeds a set privacy-centric performance threshold. If the current iteration of the intermediate global ML models does not satisfy the privacy-centric performance threshold, the merge leader entity distributes the intermediate global ML model with the multiple decentralized entities as differentially private global parameters. The multiple decentralized entities can then update their local instances of the ML algorithm using the differentially private global parameters and retrain the local instance to determine updated differentially private local parameters. Another instance of differential privacy can be applied to the updated differentially private local parameters, which are shared with a merge leader entity to update the differentially private global parameters, and so on. Whereas, if the performance metric of the current iteration of the intermediate ML model satisfies the privacy-centric performance threshold, the presently disclosed technology precedes to a next stage of the multi-stage collaborative learning approach.

During the next stage, the collaborative learning proceeds as set forth above, except that the amount (or magnitude) of differential privacy applied to the local parameters is reduced relative to the amount (or magnitude) of differential privacy applied during the preceding stage. That is, the amount of differential privacy applied to respective local parameters by each decentralized entity is lower than the amount of differential privacy applied by each decentralized entity during the preceding iteration. In examples disclosed herein, the amount of differential privacy applied during a final stage may be set to zero (e.g., no differential privacy applied), such that the final stage of learning is performed without any differential privacy applied to the local parameters. In some examples, a two-stage process is disclosed in which differential privacy is applied during a first stage and no differential privacy is applied during the second stage. In another example, a multi-stage process is provided in which differential privacy is applied during a first stage at a first amount of differential privacy noise and each subsequent stage is performed with a decreasing amount of differential privacy noise applied, until a final stage during which negligible or no differential privacy noise is applied.

Verification of model performance can be provided through a desired performance metric. For example, model performance can be gauged through model accuracy, change (e.g., delta) in a performance metric between successive iterations, validation loss, etc. Model training in general involves separating available data into training datasets and validation datasets, where after running a training iteration, a model can be evaluated on its performance by operating on data it has never seen, i.e., a validation dataset. The degree of determinations resulting from the evaluation that match the validation dataset can be referred to as the accuracy. Accuracy can be provided as a percentage. For example, in the case of a classification model, accuracy may be provided as the percentage of the validation dataset that was correctly classified compared to the total validation dataset. The degree of error or loss resulting from this evaluation can be referred to as validation loss. While accuracy and validation loss are provided herein as example performance metrics, other performance metrics may be leveraged as desired.

In an illustrative example, the privacy-centric performance threshold may be provided in terms of accuracy, such as, 80% accuracy (or other percentage as desired). Thus, a merge leader entity may evaluate the performance of the intermediate global ML model by applying a validation dataset to the intermediate global ML model and determining an accuracy of the intermediate global ML model. As detailed above, if the performance of the current iteration of the intermediate global ML model is equal to or greater than 80%, in this example, the merge leader entity distributes differentially private global parameters for use in training the global ML model during a next stage with described amount of differential privacy applied to updated local parameters. Otherwise, the merge leader entity continues with the current stage and distributes the differentially private global parameters to the multiple decentralized entities, which retrain the local instance of the ML algorithm and apply differential privacy to determine updated differentially privacy local parameters. The updated differentially private local parameters are again shared with a merge leader entity to generate an updated intermediate global ML model, and so on.

In another illustrative example, the privacy-centric performance threshold may be provided in terms of change in a performance metric (e.g., accuracy, validation loss, and the like) between successive iterations. For example, a merge leader entity may evaluate a performance metric (e.g., accuracy or the like) at a particular iteration and the same performance metric at a sequentially next iteration. If the change in the performance metric is less than a set threshold, the merge leader entity distributes differentially private global parameters for use in training the global ML model during a next stage with described amounts of differential privacy applied to updated local parameters. Smaller changes in performance between iterations may indicate that the model is converging at an optimal performance. Otherwise, the merge leader entity continues with the current stage and distributes the differentially private global parameters to the multiple decentralized entities, which retrain the local instance of the ML algorithm and apply the differential privacy according to the current stage.

The implementations disclosed herein provide various technical advantages over conventional approaches by leveraging the fact that initial iterations of collaborative training are generally more impactful on performance than later rounds. For example, generally 80% accuracy in a global ML model can be achieved in the first 5% to 20% of a total number of iterations. These initial iterations may also be more susceptible to malicious behavior. As an illustrative example, reverse engineering data may be easier during the initial iterations due to the delta (e.g., change) in performance between each iteration. For example, during training, a new weight (Wₓ*) can be computed as

$${W}_{x}^{*} = {W}_{x} - a ( {\partial }_{error} / {\partial }_{{W}_{x}} ) ,$$

where Wₓ represents the weight of a previous iteration, a represents the learning rate, and

$${\partial }_{error} / {\partial }_{{W}_{x}}$$

represents the derivative of error with respect to weight (i.e., the delta or change between iterations). As a result, a merge leader entity may be able to infer another entity's local data using its own local data as ground truth when the delta is large. Whereas, later iterations, which only incrementally improve performance, are less likely to be useful for reverse engineering other entity's local data because the impact of local data is more difficult to parse from the change in weights. Thus, by applying differential privacy during initial stages, implementations disclosed herein can provide improved privacy by securing the local data that is most susceptible to reverse engineering.

Additionally, according to various examples, the number of iterations (or batches) performed during a later stage of the multi-stage decentralized learning disclosed herein may be greater than the number of iterations (or batches) performed in a preceding stage. For example, in the case of a two-stage process, a first stage may apply differential privacy to the initial 5-20% of all training iterations based on the privacy-centric performance threshold for this stage. During the second (e.g., final) stage differential privacy may not be applied to the remaining training iterations (e.g., 95-80%). Since the number of iterations performed during the first stage (e.g., 5-20%) is small relative to the total number of iterations, the computation costs in terms of resource and time, is minimal relative to applying differential privacy to all iterations. In some examples, the final stage may perform a number of iterations that is greater than an aggregate of iterations performed in the preceding stages.

Furthermore, a final stage, according to examples disclosed herein, may provide an ML model having an optimal performance, which otherwise may not be achievable when applying differential privacy to an entire training. For example, applying differential privacy to all iterations of a training, which may provide a high degree of privacy, may not achieve optimal performance due to the presence of constant differential privacy noise. While the number of iterations can be increased in an attempt to continue to improve performance, such an approach can be costly in terms of computational resources and time. Furthermore, there may be a limit as to how close to optimal performance (e.g., a performance achievable without differential privacy applied to the entire training) can be achieved with differential privacy applied during each iteration. Thus, applying differential privacy to a first collection of iterations during the first stage and then removing the application of differential privacy for the final stage can enable convergence of the global ML model with an optimal or maximal performance (e.g., very close, for example, 1-2%, in performance relative to an entire training without differential privacy).

Accordingly, examples of the present disclosure utilize a multi-stage cascaded differential privacy framework in federated learning that balances the trade-offs of providing optimal ML model performance with reduced training time, without comprising privacy considerations. Therefore, the implementations disclosed herein can have far reaching applicability, particular in markets where data privacy is a critical consideration. For example, the implementations disclosed herein may be well suited for, but not limited to, healthcare applications, social science applications, finance applications, and any other domain in which collaborative learning can be leveraged.

While the following examples refer to “collaborative learning”, the present disclosure is not intended to be limited to by reference to collaborative learning only. As noted above, collaborate learning, which can also be referred to as federated learning, is a decentralized learning framework in which multiple decentralized entities train a model on locally held data to build a common ML model. Reference to collaborative or federated learning is not intended to be limiting, and is used as an example of decentralized learning. Accordingly, examples herein can apply equally to any decentralized learning framework where multiple decentralized entities collaborate to provide a common, global ML model by training on respective locally held data samples.

In a particular example, the present disclosure can be applied to Swarm Learning. Swarm Learning, according to examples, leverages blockchain technology to allow for decentralized control of ML training while ensuring trust and security amongst the individual decentralized entities.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

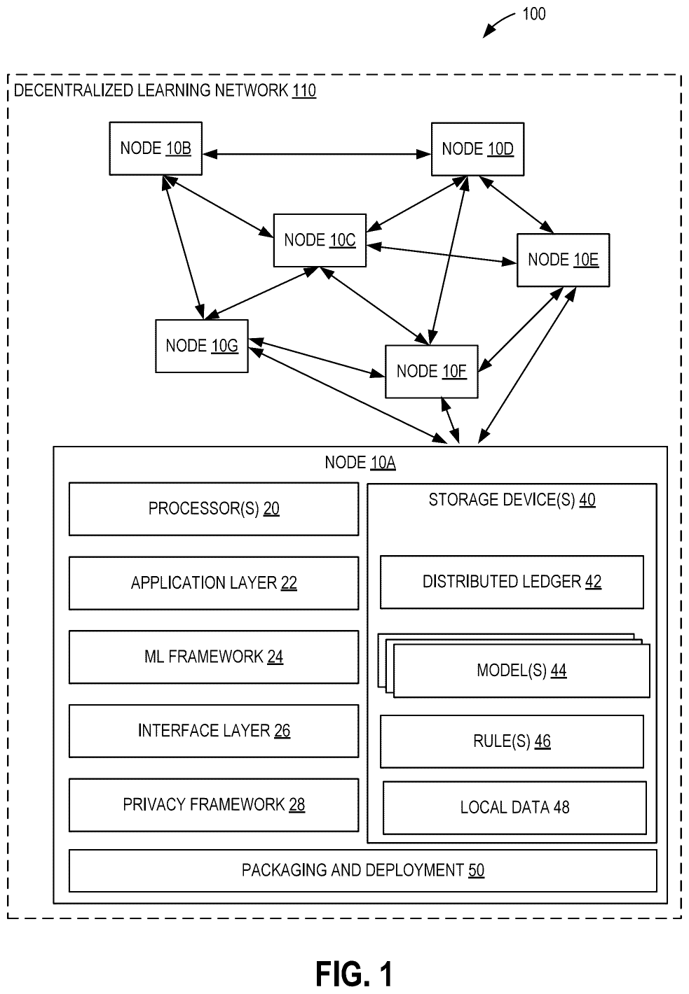

FIG. 1 illustrates an example system 100 for decentralized learning, according to an example implementation of the disclosure. Example system 100 comprises a decentralized learning network 110 with a plurality of network nodes 10A-10G in a cluster or group of network nodes (also referred to collectively as nodes 10 or individually as nodes 10A-10G). The decentralized learning network 110 may be, in this example, a Swarm Learning network. However, the present disclosure is not limited to Swarm Learning networks, which is used herein for illustrative purposes only. Aspects disclosed herein can be implemented in any other collaborative learning network topology that comprises a plurality of network nodes.

Each node 10 may be coupled to other nodes 10 via a network, which may include any one or more of, for instance, the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network. Furthermore, according to various implementations, the components described herein may be implemented in hardware and/or software that configure hardware.

The plurality of nodes 10 in the cluster in decentralized learning network 110 may comprise any number, configuration, and connections between nodes 10. As such, the arrangement of nodes 10 shown in FIG. 1 is for illustrative purposes only. Node 10 may be a fixed or mobile computing device. While node 10A is illustrated in detail in FIG. 1, each of nodes 10 may be configured in the manner illustrated. In the example of FIG. 1, node 10A includes one or more processors 20 (interchangeably referred to herein as processors 20, processor(s) 20, or processor 20 for convenience) and one or more storage devices 40 (interchangeably referred to herein as storage devices 40, storage device(s) 40, or storage device 40 for convenience), as well as other components. The storage device(s) 40 may hold (e.g., store) data 48 that is locally accessible to the node 10A (referred to herein as local data). The local data 48 may not be accessible to other nodes 10 in the decentralized learning network 110 (e.g., nodes 10B-10G in this example).

In some examples, the storage device(s) 40 may store a distributed ledger 42, one or more models 44 (interchangeably referred to herein as models 44, model(s) 44, or model 44 for convenience), and/or rule(s) 46. The distributed ledger 42 may include a series of blocks of data that reference at least another block, such as a previous block. In this manner, the blocks of data may be chained together as distributed ledger 42. The distributed ledger 42, in some examples, may store blocks that indicate a state of node 10A a relating to its machine learning during an iteration. Thus, the distributed ledger 42 may store an immutable record of the state transitions of a node 10A. In this manner, the distributed ledger 42 may store a current and historic state of a model 44. It should be noted, however, that in some embodiments, some collection of records, models, and smart contracts from one or more of other nodes (e.g., node(s) 10B-10G) may be stored in distributed ledger 42.

Model 44 may be locally trained at a node 10 based on the locally accessible data, as described herein, and then updated based on model parameters learned at other nodes 10. The nature of the model 44 will be based on the particular implementation of the node 10 itself. For instance, model 44 may be defined by learned parameters relating: to self-driving vehicle features such as sensor information as it relates object detection, network configuration features for network configurations, security features relating to network security such as intrusion detection, healthcare features related to medical records and health-related information of patients, social science features related to human behavior in social and cultural sematic aspects, and/or other context-based models.

Model 44 can be stored as a local instance of an ML algorithm, as well as learned parameters determined by training the ML algorithm on the locally accessible data. Local parameters can be stored as weights and/or biases that can define a particular model 44. The model(s) 44 can refer to local ML models. Model(s) 44 can include any model of general class of ML algorithms, including but not limited to, many statistical and classical ML algorithms in use by verticals, such as regression-based, Decision Tree (DT), Support Vector Machine (SVM), etc. Training methods can include, but are not limited to, standard batch training.

Rules 46 may include smart contracts or computer-readable rules that configure nodes to behave in certain ways in relation to decentralized machine learning and enable decentralized control. For example, rules 46 may specify deterministic state transitions, when and how to elect a voted merge leader node, when to initiate an iteration of machine learning, whether to permit a node to enroll in an iteration, a number of nodes required to agree to a consensus decision, a percentage of voting participant nodes required to agree to a consensus decision, and/or other actions that node 10A may take for decentralized machine learning.

Rules 46 may specify hyperparameters that define how the ML framework 24 and privacy framework 28 is structured. Hyperparameters can be thought of as a mechanism for governing the training process, e.g., deciding how many training iterations (or batches) should be performed, how many nodes 10 perform local training during each iteration, setting training stopping criteria (e.g., performance thresholds for determining when to stop training), and so on. Hyperparameters can be adjustable parameters, set in advance, that can be tuned to obtain/generate an ML model/algorithm with optimal/tuned performance. In some examples, hyperparameters may be set by an operator via a frontend dashboard.

According to examples disclosed herein, rules 46 may include a hyperparameter specifying a number of decentralized learning stages of a multi-stage decentralized learning performed by system 100. In this case, a particular stage may include locally training model 44 at a node 10A based on the locally accessible data, as described herein, and updating model 44 based on model parameters learned at other nodes 10. At completion of the particular stage, an intermediate global model can be obtained based on model parameters learned at nodes 10. The intermediate global model of the particular stage can be used to update the model 44 at node 10A for a sequentially next stage. This process can be repeated for the number of stages specified in the hyperparameters.

The hyperparameters may also specify a privacy budget for the decentralized learning, which may be specified as an amount of differential privacy to be applied during the decentralized learning. An amount of differential privacy may be specified as a magnitude of noise, randomness, or bias (referred to herein as differential privacy noise) that can be applied by privacy framework 28 for securing privacy of data. For example, in the case of differential privacy, a privacy budget may be specified as ε-differential privacy (also referred to herein as ε), which is a quantifiable measure of privacy. A smaller value of ε, which corresponds to a large amount of differential privacy, indicates a stronger privacy guarantee (e.g., the privacy of the data is increased). The value of ε represents an amount of differential privacy noise that is applied to the data. Thus, a smaller ε value means more differential privacy noise is added, which provides stronger privacy guarantees. For example, the differential privacy decreases exponentially as the value of ε increases. In examples, ε having values between zero to one can be considered highly private, while values between two and 10 can be considered moderately private. Values of ε above 10 can be considered as having negligible or no privacy, and may be similar to sharing the data without any differential privacy applied.

In the case of multi-stage decentralized learning, the hyperparameters may specify a privacy budget for each stage. According to various examples disclosed herein, a privacy budget for a particular stage may be lower than the privacy budget for a preceding stage, except for an initial (e.g., first) stage which may have the largest privacy budget relative to other stages. For example, the hyperparameters of rules 46 may specify a number of stages to be performed in a cascaded order, along with a value of ε for each stage that represents an amount of differential privacy noise of that stage. The value of ε for a first stage may be smaller than a value of ε for a successively next stage. In some examples, the value of E for the final stage may be set to greater than 10, which represents that negligible or no differential privacy noise is to be applied during the final stage. In some examples, the value of ε for the first stage may be set to less than one. In examples comprising more than two stages, the value of ε for stages between the first and final stage may be set to values equal to and/or between one and 10. However, values of ε may be set to a desired privacy budget for a given application.

Processor(s) 20 may obtain local data 48 accessible locally to node 10A but not necessarily accessible to other nodes 10A. Such local data 48 may include, for example, private data not intended to be shared with other devices, while local model parameters that are learned from the private data can be shared. Processor(s) 20 may be programmed by one or more computer program instructions. For example, processors 20 may be programmed to execute application layer 22, ML framework 24, interface layer 26, privacy framework 28, or other instructions to perform various operations, each of which are described in greater detail herein. As used herein, for convenience, the various instructions will be described as performing an operation, when, in fact, the various instructions program processors 20 (and therefore node 10A) to perform the operation.

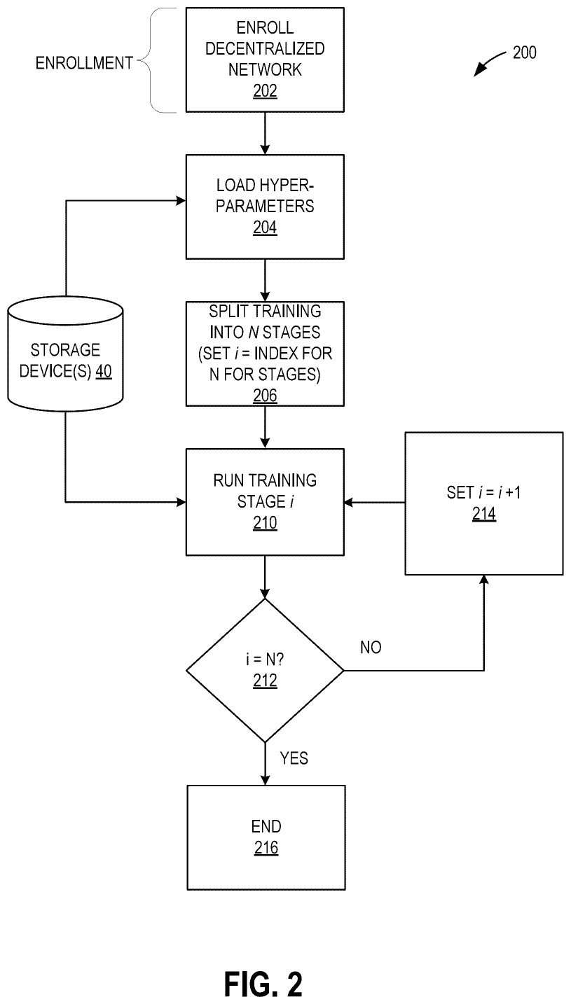

Application layer 22 may execute applications on the node 10A. For instance, application layer 22 may include a blockchain agent (not illustrated) that programs node 10A to participate in a decentralized machine learning across decentralized learning network 110 as described herein. In examples each node 10 may be programmed with the same blockchain agent, thereby ensuring that each acts according to the same set rules, such as those which may be encoded using rules 46. For example, the blockchain agent may program each node 10, according to hyperparameters specified by rules 46, to act as a participant node as well as a merge leader node (if elected to serve that roll). Additionally, the blockchain agent may program each node 10 to, according to hyperparameters specified by rules 46, execute differential privacy by applying a differential privacy noise according to the process further described below in connection with FIG. 2. Application layer 22 may execute machine learning through the ML framework 24 and privacy framework 28.

ML framework 24 may train a model based on local data 48 held at node 10A. For example, ML framework 24 may generate one or more model parameters by applying the local data 48 to which node 10A has access to a local instance of an ML algorithm (e.g., model 44). The ML framework 24 learns weights and/or bias as one or more model parameters (referred to interchangeably herein as “one or more local parameters” or “local parameter(s)”), which can define a particular model 44 and stored in storage device 40. In an example, the ML framework 24 may use the TensorFlow™ machine learning framework, although other frameworks may be used as well.

Application layer 22 may use interface layer 26 to interact with and participate in the decentralized learning network 110 for collaborative machine learning across multiple participant nodes 10. Interface layer 26 may communicate with other nodes using blockchain by, for example, broadcasting blockchain transactions and writing blocks to the distributed ledger 42 based on those transactions.

Interface layer 26 may share the local parameter(s) and inferences with the other participant nodes 10. Interface layer 26 may include a messaging interface used to communicate via a network with other participant nodes 10. The messaging interface may be configured as a Secure Hypertext Transmission Protocol (“HTTPS”) microserver. Other types of messaging interfaces may be used as well. Interface layer 26 may use a blockchain Application Programming Interface (API) to make calls for blockchain functions based on a blockchain specification. Examples of blockchain functions include, but are not limited to, reading and writing blockchain transactions and reading and writing blockchain blocks to the distributed ledger 42. One example of a blockchain specification is the Ethereum specification. Other blockchain specifications may be used as well.

Interface layer 26 may include a consensus engine that facilitates writing of data to the distributed ledger 42. For example, in some instances, a merge leader node (e.g., one of the participant nodes 10) may use the consensus engine to decide when to merge local parameters received from nodes 10, write an indication that its state has changed as a result of merging local parameters to the distributed ledger 42, and/or to perform other actions. In some instances, any participant node 10 (whether a merge leader node or not), may use the consensus engine to perform consensus decisioning such as whether to enroll a node to participate in an iteration of machine learning. In this way, a consensus regarding certain decisions can be reached after data is written to distributed ledger 42.

Privacy framework 28 may ensure privacy and confidentiality in the local data 48 of node 10A. For example, privacy framework 28 may be executed to implement differential privacy by introducing noise, randomness, or other bias to data, thereby providing a privacy guarantee to the data. Privacy framework 28 may apply an amount of differential privacy noise to each data sample according to a privacy budget specified in rules 46 (e.g., a specified value of ε). According to examples disclosed herein, privacy framework 28 generates one or more differentially private local parameters based on the one or more local parameters generated by the ML framework 24 and the amount of differential privacy specified by rules 46. For example, the privacy framework 28 receives the one or more local parameters from the ML framework 24 and perturbs each local parameter by applying the amount of differential privacy noise specified by rules 46 to each local parameter, thereby generating differentially private local parameters and securing (e.g., providing a privacy guarantee) the underlying local data 48 from which the local parameters are determined. In another example, the privacy framework 28 can obtain the local data 48 from storage device(s) 40 and perturbs the local data 48 by applying the amount of differential privacy noise specified by rules 46 to each data sample, thereby generating differentially private local data. The differentially private local data may then be utilized by the ML framework 24, as described above, to provide differentially private local parameters, thereby securing (e.g., providing a privacy guarantee) the underlying local data 48 from which the local parameters are determined.

In some implementations, node 10A can include packaging and deployment 50 that may package and deploy a model 44 as a containerized object. For example, packaging and deployment 50 may package local parameter(s) (or differentially private local parameter) and other inferences into a containerized object that can be shared with other participant nodes 10. In the case of a merge leader node, packaging and deployment 50 may package merged local parameter(s) (e.g., global parameter(s)) into a containerized object that can be distributed to other participant nodes 10. For example, and without limitation, packaging and deployment 50 may use the Docker platform to generate Docker files that include models 44. Other containerization platforms may be used as well. In this manner various applications at node 10 may access and use the model 44 in a platform-independent manner. As such, the models may not only be built based on collective parameters from nodes in a decentralized learning network, but also be packaged and deployed in diverse environments.

Each iteration of model building (also referred to herein as an epoch of machine learning or model training) may include multiple phases, such as first and second phases. In the first phase, each participant node 10 trains its local model independently of other participant nodes 10 using its local training dataset, which may be accessible locally to the participant node but not to other nodes. As such, each participant node 10 may generate local parameter(s) resulting from the local training of an instance of an ML algorithm on local datasets. In the second phase, the participant nodes 10 may each share the local parameter(s) with the decentralized learning network 110. For example, each participant node 10 may share its local parameter(s) to a merge leader node, which is elected from among the nodes in the decentralized learning network 110. The merge leader node may merge the local parameters from the participant nodes 10 to generate global parameters for the current iteration. The global parameters, which define a global model, may be distributed to the participant nodes 10, which each update their local state. For example, each participant node 10 updates its local instances of the ML algorithm using the shared global parameters thereby providing a common, global ML model at each node 10. If another iteration of training is to be executed, each node 10 executes the first phase again by retraining its local ML algorithm using its local data to generate updated local parameter(s), and the process repeats as set forth above to further refine the global parameter(s) and ultimately the global model.

Model building may include multiple stages, each of which includes a number of iterations as set forth above. As alluded to above, the number of stages may be specified in rules 46 and each stage may be associated with a privacy budget. During an initial (e.g., first) stage, and during a first phase of a given iteration as described above, each participant node 10 trains its local model independently of other participant nodes 10 using its local training dataset to generate local parameter(s). Each participant node 10 also applies an amount of differential privacy, as specified in rules 46, to the local parameter(s) to generate differentially private local parameter(s). In the second phase of the given iteration, the participant nodes 10 may each share the differentially private local parameter(s) with a merge leader node, as described above. The merge leader node may merge (e.g., aggregate) the differentially private local parameters from the participant nodes 10 to generate differentially private global parameters for the current iteration. During a next stage, the differentially private global parameters, which define an intermediate global model, may be distributed to the participant nodes 10, which each update their local state, as described above. If another stage of training is to be executed, each node 10 executes the first phase again by retraining its local ML algorithm using its local data 48 to generate updated local parameter(s) and applies an amount of differential privacy, as specified in rules 46, to the updated local parameter(s). The amount of differential privacy applied during this subsequent stage may be less than the amount applied during the initial stage. The process repeats through the specified number of stages, as set forth above, to further refine the global parameter(s) and ultimately the global model. As noted above, the final stage may be performed with the amount of differential privacy set to zero.

As noted above, the network 110 can be a network such as a Swarm Learning network. Swarm Learning can involve various stages or phases of operation including, but not limited to: initialization and onboarding; installation and configuration; and integration and training. Initialization and onboarding can refer to a process (that can be an offline process) that involves multiple entities interested in swarm-based ML to come together and formulate the operational and legal requirements of the decentralized system. This includes aspects such as but not limited to data (parameter) sharing agreements, arrangements to ensure node visibility across organizational boundaries of the entities, a consensus on the expected outcomes from the model training process. Values of configurable parameters provided by a Swarm Learning network, such as the peer-discovery nodes supplied during boot up and the synchronization frequency among nodes, are also finalized at this stage. Moreover, the common (global) model to be trained and the reward system (if applicable) can be agreed upon.

Once the initialization and onboarding phase is complete, nodes 10 of FIG. 1 may download and install a Swarm Learning platform/application onto their respective machines, i.e., nodes. The Swarm Learning platform/application may then boot up, and each node's connection to the swarm learning/swarm-based blockchain network can be initiated. As used herein, the term Swarm Learning platform/application can refer to a blockchain overlay on an underlying network of connections between nodes 10. In an example, the boot up process can be an ordered process in which the set of nodes designated as peer-discovery nodes (during the initialization phase) are booted up first, followed by the rest of the nodes 10 in the network 110.

With regard to the integration and training phase, the Swarm Learning platform/application can provide a set of APIs that enable fast integration with multiple frameworks. These APIs can be incorporated into an existing code base for the Swarm Learning platform/application to quickly transform a stand-alone ML node into a swarm learning participant. It should be understood that “participant” and “node” may be used interchangeably in describing various examples.

At a high level, model training in accordance with various examples may be described in terms of enrollment, local model training, parameter sharing, parameter merging, and stopping criterion check. FIG. 2 illustrates a process 200 that can be performed by the decentralized learning network in accordance with examples disclosed herein. In an example, the operations of process 200 can be performed, for example, by one or more nodes 10 of FIG. 1. In an illustrative example, one or more of the operations of process 200 may be performed by, for example, by one or more of the application layer 22, ML framework 24, interface layer 26, and/or privacy framework 28, as executed by processor(s) 20.

At operation 202, enrollment occurs. For example, in the case of Swarm Learning, each node in the decentralized learning network may enroll or register itself in a swarm learning contract. In one example, this can be a one-time process. In other examples, enrollment or registration may be performed after some time as a type of verification process. Each node can subsequently record its relevant attributes in the swarm learning contract, e.g., the uniform resource locator (URL) from which its own set of trained parameters can be downloaded by other nodes.

At operation 204, hyperparameters can be loaded from storage device(s) 40, for example, into the ML framework 24. As noted above, hyperparameters that define how the ML framework 24 and privacy framework 28 are structured. Hyperparameters may be selected for use at each node and training can be performed according to those hyperparameters. In examples, the hyperparameters may govern the training process, e.g., by specifying how many training stages should be performed, how many training iterations (or batches) should be performed for each training stage, how many nodes (e.g., nodes 10) perform local training during each iteration, setting training stopping criteria, and so on. The hyperparameters may also specify the privacy budget (e.g., ε-differential privacy) for each stage specified.

At operation 206, the training can be split into a number (N) of stages as specified by the hyperparameter. Further, an index i can be provided as a counter for the stages used in training. Initially, i can be set to an index of the first stage (e.g., 1).

At operation 210, an i^{th} stage of training occurs, where each node proceeds to train a local copy (e.g., instance) of a common ML algorithm in an iterative fashion over multiple epochs. In the current example, i is set to one for the first stage. During the first stage, the nodes perform local training on local instances of the ML algorithm using local data to learn respective local parameters. The nodes apply differential privacy according to privacy budgets specified in the hyperparameters, and share the resulting differentially private local parameters to a merge leader entity. The merge leader node derives differentially private global parameters by merging the shared differentially private local parameters, which represent an intermediate global ML model. The merge leader node shares the differentially private global parameters and each node updates its local model (e.g., the local instance of the common ML algorithm) with the differentially private global parameters. The merge leader node verifies the performance of the intermediate global ML model, and, if the performance satisfies a privacy-centric performance threshold, process 200 proceeds to operation 212.

At operation 212, a determination is made as to whether the counter i for indexing stages has reached a set number of total stages (e.g., i=N). If the counter i has not yet reached the number of total stages, the process 200 can proceed to operation 214. At operation 214, the counter i is incremented. Incrementing the counter i can cause the process 200 to transition the next training stage (e.g., stage i+1), which can be performed by executing an instance of operation 210 according to hyperparameters for the next training stage. In examples, each subsequent training stage may apply a sequentially smaller amount of differential privacy as compared to a preceding training stage. In examples, the differential privacy may be inversely proportional to the value of counter i. In some examples, the amount of differential privacy may decrease linearly. In another example, the amount of differential privacy may decrease exponentially.

The process 200 repeats operations 210 through 214 until the counter i reaches the total number of stages. During the final training stage (e.g., stage N−1), the performance threshold used to verify model performance may be referred to as a performance-centric threshold, indicative that an optimal performance of the global model has been achieved by the process 200. When the counter i has reached the number of total stages, then process 200 can proceed to operation 216.

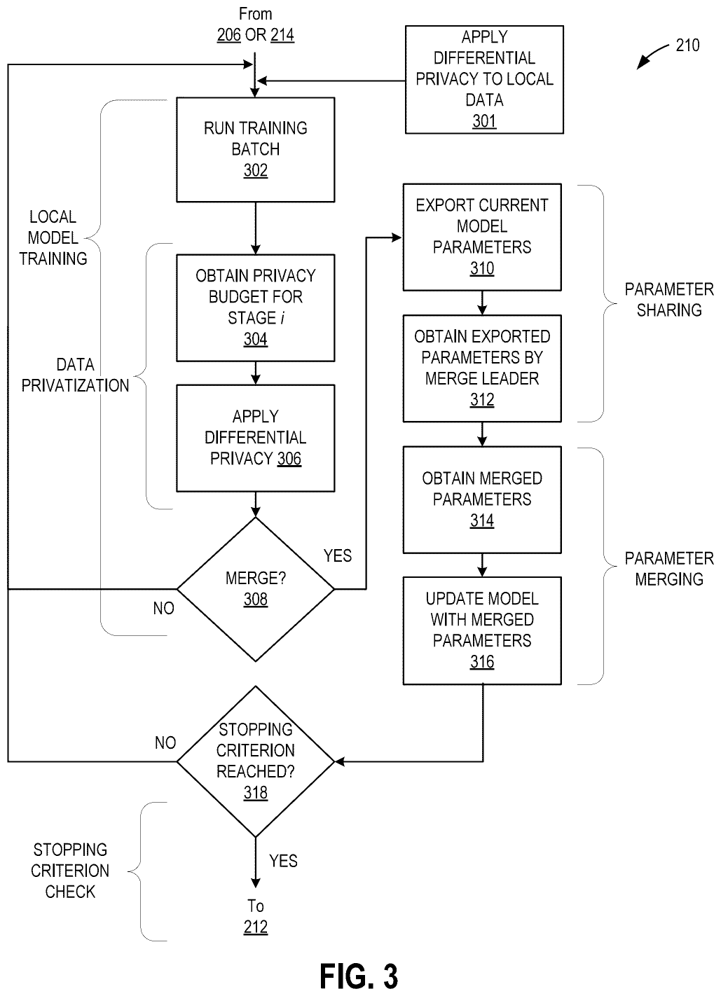

FIG. 3 illustrate an example of sub-operations performed by operation 210 that can be performed during an i^{th} training stage, in accordance with examples disclosed herein.

At operation 302, a first instance of local training occurs for the i^{th} training stage, where each node proceeds to train a local copy of the global or common algorithm in an iterative fashion over multiple rounds that can be referred to as epochs. During each epoch, each node trains its local ML algorithm using one or more batches of local data for some given number of iterations. For example, each node can perform a local training on its local instance of the common ML algorithm using a batch of local data to determine one or more respective local parameters. The one or more local parameters can be provided as weights and/or biases that can, when applied to the ML algorithm, provide for a local instance of the common ML model.

At operation 304, a privacy budget for the i^{th} training stage (e.g., the current training stage), as specified by the hyperparameters, can be obtained. Then, at operation 306, each node applies differential privacy to its respective one or more local parameters based on the privacy budget obtained at operation 304. For example, differential privacy may be applied by introducing differential privacy noise to local parameters, thereby providing a privacy guarantee to the local data from which the local parameters where determined.

Operation 306 may include applying an amount of differential privacy noise, according to the privacy budget (e.g., a specified value of ε), to each local parameter, for example, by perturbing each local parameters by adding the specified value of ε. For example, during a first training stage, where i equals 1, differential privacy may be applied by introducing the highest amount of differential privacy noise (e.g., lowest value of ε), relative to later training stages, to local parameters. During subsequent training stages, the amount of differential privacy noise applied may be less than a preceding training stages (e.g., the amount of differential privacy noise for a given training stage is less than the amount for an immediately preceding training stage). During a final training stage (e.g., i is equal to N), the amount of differential privacy noise may be set to negligible or zero, in which case operation 306 can be considered as not applying differential privacy to the local parameters (e.g., no privacy guarantee attributable to the final stage). The local parameters resulting from operation 306 can be considered differentially private local parameters in a case where the differential privacy noise applied is non-zero (e.g., ε is less than 10).

A check to determine if one or more local parameters can be merged may be performed at operation 308. The check can determine if a threshold number of iterations has been reached and/or whether a threshold number of nodes are ready to share their respective local parameters. These thresholds can be specified during the initialization phase, for example, as hyperparameters. If the determination at operation 308 is negative, operation 210 returns to operation 302 to perform another iteration of training (e.g., each node trains its local ML algorithm using one or more other batches of local data). If the determination at operation 304 is affirmative, operation 210 proceeds to operation 310. The local parameters from operation 308 (e.g., differentially private local parameters or otherwise) of each node can be exported to a file, which can be uploaded to a shared file system for other nodes to access. Each node may signal to the other nodes that it is ready to share its differentially private local parameters. It should be understood that sharing in this context can refer to a node transmitting its differentially private local parameters, e.g., to a merge leader node.

Once parameter sharing commences, current local parameters may be exported at operation 310 and the exported parameters can be sent to a merge leader node at operation. The local parameter sharing phase can begin with the election of a merge or epoch leader, whose role is to merge the local parameters derived after local training on the common ML algorithm at each of the nodes and apply differential privacy noise based on the privacy budget for the current training stage. This election of a merge or epoch leader can occur after each epoch. While it is possible to elect a node to act as the merge leader across multiple epochs, electing a merge leader after each epoch can help to ensure privacy by changing which node has the public key. Additionally, the application of differential privacy at operation 306 helps to further ensure privacy of local data from a malicious merge leader. Upon selection of one of the nodes of the decentralized learning network to be the merge leader, the merge leader may pull the parameter files from each node. For example, the URL information of each participant or node can be used by the merge leader to download the parameter files from each node. Examples herein can be implemented using any desired network topology that comprises a plurality of network nodes. In one example, a star topology can be used, where a single merge leader performs the merge. In other examples, other topologies, such as a k-way merge, where the merge is carried out by a set of nodes may also be used. It will be appreciated that these are merely example topologies, and the examples herein are not limited to these topologies only.

The merge leader may then merge the received parameter files (from each node). Any appropriate merge mechanisms or algorithms may be used, e.g., one or more of mean merging, weighted mean merging, median merging, etc. The merge leader may combine the parameter values from the nodes to create a new file with the merged parameters (also referred to as global parameters), and signals to the other nodes that a new file is available. Merged parameters result from merging differentially private local parameters, such as during each training stage except the final stage, may be referred to as differentially private merged parameters (or differentially private global parameters) due to the application of non-zero differential privacy noise applied during the respective training stage.

At operation 314, each node may obtain the merged parameters (represented in the new file) from the merge leader. For example, each node may pull a merged parameter file from the merge leader. For example, URL information of the merge leader node can be used by each of the nodes to download the merged parameter file from the merged leader. At operation 316, each node may update its local version of the common ML model with the merged parameters. For example, at operation 316 each node may apply the merged parameters (e.g., differentially private merged parameters or otherwise depending on the current training stage) to its local instance of the common ML algorithm to generate an update local instance.

At operation 318, a check can be performed to determine if a stopping criterion has been reached. For example, each of the nodes may evaluate the model with the updated merged parameter using their local data (e.g., a validation data set from the local data) to calculate various validation metrics. The values obtained from this operation can be shared using a smart contract state variable. As each node completes this step, it signals to the decentralized learning network that the update and validation step is complete. In the interim, the merge leader may keep checking for an update complete signal from each node. When it discovers that the merge participants have signaled completion, the merge leader merges the local validation metric numbers to calculate global metric numbers. This updating of the model can be thought of as a synchronization step. The current state of the decentralized network can be compared against a stopping criterion, and if it is found to be met, the operation 210 proceeds to operation 212 described above. Otherwise, the steps of local model training, parameter sharing, parameter merging, and stopping criterion check are repeated until the criterion is fulfilled.

In some examples, operation 318 may comprise comparing the current state of the decentralized learning network to a performance threshold as the stopping criterion. In this case, each of the nodes may evaluate its local version of the model using a validation dataset of its local data (e.g., the batch of local data used in training at operation 302, referred to as training data, is separate from the batch of local data used in validation here) to calculate a local performance metric as the validation metric. Nodes may calculate performance metrics as, for example but not limited to, an accuracy of each local model in making correct inferences from the validation dataset with the validation dataset as ground truth, a degree or measure of change (e.g., delta) between performance metrics of sequential iterations, and validation loss, among others.

Once the merge leader receives the update complete signal from each node, the merge leader merges the local performance metrics to calculate a global performance metric. The merging mechanism used to merge the performance metrics may be the same or different from that used to merge the local parameters. The merged global performance metric can be compared to a corresponding performance threshold to determine if the stopping criterion is met. The performance threshold may be provided as, for example, but not limited to, a global accuracy resulting from merging the locally determined accuracies, a merged degree or measure of change (e.g., delta) between performance metrics of sequential iterations, and merged validation loss, among others. In some examples, the performance threshold may be specified as a hyperparameter and the value of the threshold may be set as desired for a given application. The more stringent the performance threshold, the more likely that the model has converged with an optimal model.

In a case where the performance metric that is validated at each node is accuracy, the merge leader compares the global accuracy to a threshold accuracy (e.g., 80% or other performance set as desired). If the global accuracy is equal to or greater than the threshold, then the stopping criterion is considered met and the process proceeds to operation 212. Otherwise, the steps of local model training, parameter sharing, parameter merging, and stopping criterion check are repeated until the criterion is fulfilled.

In the case where validation loss is used as the performance metric validated at each node, the merge leader compares the global validation loss to a threshold loss (e.g., 0.15 or other performance set as desired). In some cases, validation loss may be a value between 0 and 1, where a smaller value corresponds to better performance. If the global validation loss is equal to or less than the threshold, then the stopping criterion is considered met and the process proceeds to operation 212. Otherwise, the steps of local model training, parameter sharing, parameter merging, and stopping criterion check are repeated until the criterion is fulfilled.

In the case where degree or measure of change (e.g., delta) between performance metrics (e.g., accuracy, validation loss, or the like) of sequential iterations is validated at each node, the merge leader compares the global change to a threshold change (e.g., 0.05% or other performance set as desired). In some examples, the merge leader may track the change across a number of continuous iterations (e.g., 2, 3, 4, 5, or other number desired for a given application) and check that the change is consistently below the threshold change for the number of iterations. A consistent change (e.g., below 0.05%) across the number of continuous iterations indicates that the global model is stabilizing and is not likely to experience significant changes in future iterations. If the global change is equal to or less than the threshold, then the stopping criterion is considered met and the process proceeds to operation 212. Otherwise, the steps of local model training, parameter sharing, parameter merging, and stopping criterion check are repeated until the criterion is fulfilled.

In some examples, the merge leader may evaluate the model with the updated merged parameters using its local data (e.g., a validation data set from its local data) to calculate various validation metrics. In this case, the merge leader may not collect metrics from the nodes. Instead, the merge leader can calculate a global metric directly from the merged parameters and compare the results to the stopping criterion as set forth above.

The term “privacy-centric performance threshold” or “privacy-centric stopping criterion” is used to refer to performance thresholds for training stages in which the applied differential privacy is non-zero (e.g., stage 1 through stage N−1). These training stages can be considered privacy-centric because the primary concern during these stages is ensuring a privacy guarantee in accordance with the privacy budget for each training stage. Whereas, the primary concern during the final stage (e.g., stage N) is to provide a global model that converges with an optimal performance and differential privacy noise is set to zero. The privacy threshold for the final stage can be referred to herein as a “performance-centric performance threshold” or “performance-centric stopping criterion.”

While the operations shown in FIGS. 2 and 3 are described as occurring in an illustrative order, examples disclosed herein are not intended to be limited to the specific sequence described, unless explicitly required. For example, operations 304 and 306 may be performed after operation 308 in some implementations. In this case, only once operation 308 determines that local parameters can be merged do the nodes perform differential privacy on respective local parameters as described in connection with operations 304 and 306.

In some examples, optional operation 301 can be performed prior to running a training batch at operation 302. Operation 301 can be substantially similar to operations 304 and 306, except that operation 301 can be performed by each node to apply differential privacy to local data. For example, a privacy budget can be obtained as described above in connection with operation 304 and the differential privacy can be applied to local data as described above in connection with operation 306. Thus, in this example, operation 302 can be executed on differentially private local data to generate differentially private local parameters. In some implementations where operation 301 is performed, operations 304 and 306 may become optional.

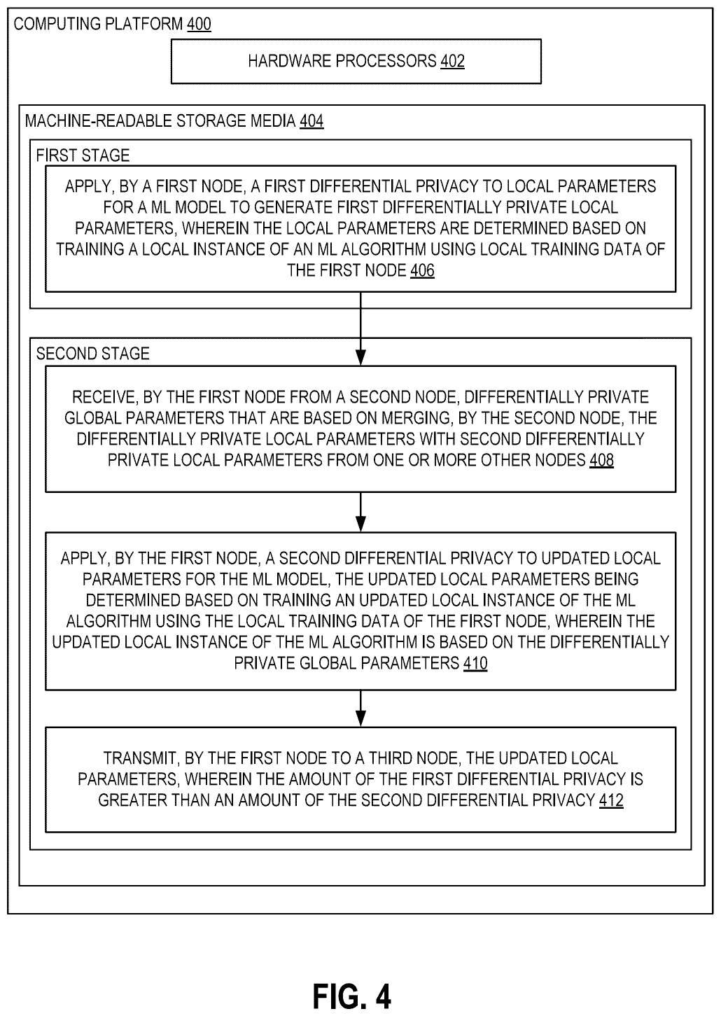

FIG. 4 illustrates an example computing component that may be used to implement multi-stage privacy (also referred to as cascaded-privacy) decentralized learning in accordance with various embodiments. Referring now to FIG. 4, computing component 400 may be, for example, a server computer, a controller, or any other similar computing component capable of processing data. In the example implementation of FIG. 4, the computing component 400 includes a hardware processor 402, and machine-readable storage medium for 404. In examples disclosed herein, the computing component may be an example of a node 10 of FIG. 1.

Hardware processor 402 may be one or more central processing units (CPUs), semiconductor-based microprocessors, and/or other hardware devices suitable for retrieval and execution of instructions stored in machine-readable storage medium 404. Hardware processor 402 may fetch, decode, and execute instructions, such as instructions 406-410, to control processes or operations for cascaded-privacy collaborative learning. As an alternative or in addition to retrieving and executing instructions, hardware processor 402 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 404, may be any electronic, magnetic, optical, or other physical storage device that contains or stores executable instructions. Thus, machine-readable storage medium 404 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 404 may be a non-transitory storage medium, where the term “non-transitory” does not encompass transitory propagating signals. As described in detail below, machine-readable storage medium 404 may be encoded with executable instructions, for example, instructions 406-410.

Hardware processor 402 may execute instruction 406 to, during a first stage of training a machine learning (ML) algorithm, apply, by a first node, a first differential privacy to one or more local parameters for an ML model to generate one or more first differentially private local parameters. In examples, the local parameters are determined based on training a local instance of an ML algorithm using local training data of the first node. In some examples, an amount of the first differential privacy may be specified as a privacy budget (e.g., as a hyperparameter) and applied, for example, by perturbing the determined local parameters, for example, as described above in connection with FIGS. 1-3.

Hardware processor 402 may execute instruction 408 to, during a second stage of training the ML algorithm, receive, by the first node from a second node, one or more differentially private global parameters. The one or more differentially private global parameters may be based on merging, by the second node, the one or more differentially private local parameters with second differentially private local parameters from one or more other nodes. In examples, an amount of the first differential privacy is greater than an amount of the second differential privacy, as described above in connection with FIGS. 1-3. For example, in some implementations (e.g., where the second stage is the last stage), the amount of the second differential privacy is zero.

Hardware processor 402 may execute instruction 410 to, during the second stage, apply, by the first node, a second differential privacy to one or more updated local parameters for the ML model. The one or more updated local parameters may be determined based on training an updated local instance of the ML algorithm using the local training data of the first node and the updated local instance of the ML algorithm is based on the one or more differentially private global parameters, for example, as described above in connection with FIGS. 1-3.

Hardware processor 402 may execute instruction 410 to, during the second stage, transmit, by the first node to a third node, the one or more updated local parameters.

According to some examples, the first stage comprises generating a intermediate ML model based on the merging of the one or more differentially private local parameters with the second differentially private local parameters. In this case, transitioning from the first stage to the second stage based on a performance of the intermediate ML model satisfying a threshold performance, as described above in connection with FIGS. 1-3. For example, the merged or global model resulting from an instance of operation 210 may be considered an intermediate ML model. In other examples, global or local models at operation 316 may be considered intermediate ML models in accordance with the implementation disclosed herein. The performance threshold, according to some examples, can comprise one of: a threshold accuracy of the intermediate ML model, a validation loss of the intermediate ML model, and a measure of change between a performance metric between successive iterations of training, as described above in connection with FIGS. 1-3.

In some examples, the first stage may include transmitting, by the first node, the one or more first differentially private local parameters to a second node. The second node may receive the second differentially private local parameters from the one or more other nodes, for example, as described above in connection with FIGS. 1-3. The second differentially private local parameters may be based on applying at least third differential privacy to local parameters determined by training local instances of the ML algorithm using local training data of the one or more nodes. The third differential privacy may be of the same amount as the first differential privacy or a different amount.

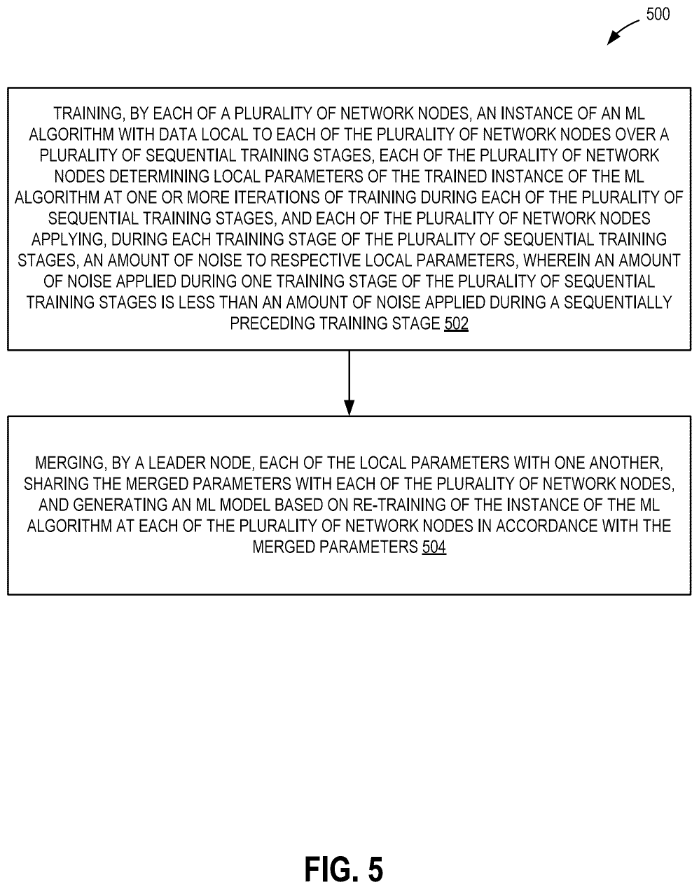

FIG. 5 is an example of operations that may be performed by a multi-stage privacy decentralized learning system in accordance with the implementations disclosed herein. FIG. 5 illustrates an example process 500 that may be performed by, for example, system 100 of FIG. 1.

At operation 502, each of a plurality of network nodes train an instance of an ML algorithm with data local to each of the plurality of network nodes over a plurality of sequential training stages. For example, each of the plurality of network nodes determine local parameters of the trained instance of the ML algorithm at one or more iterations of training during each of the plurality of sequential training stages, and each of the plurality of network nodes apply, during each training stage of the plurality of sequential training stages, an amount of noise to respective local parameters. As described above, an amount of noise (e.g., based on a value of ε-differential privacy) applied during one training stage of the plurality of sequential training stages is less than an amount of noise applied during a sequentially preceding training stage. In an illustrative example, the amount of noise applied during a final stage may be set to zero (e.g., ε-differential privacy having a value of 10 or more). Furthermore, as described above in connection with FIGS. 1-3, the plurality of network nodes may transition from one training stage to the next based on a performance of the ML model satisfying a stopping criterion.

At operation 504, a leader node merges each of the local parameters with one another. That is, for example, for each iteration during a given stage, the leader node merges local parameters (including the applied noise) together to provide merged (e.g., global) parameters. The leader node may share the merged parameters with each of the plurality of network nodes and generate an ML model based on the merged parameters. The ML model can be further refined and updated based on re-training of the instance of the ML algorithm at each of the plurality of network nodes in accordance with the merged parameters during a subsequent iteration.

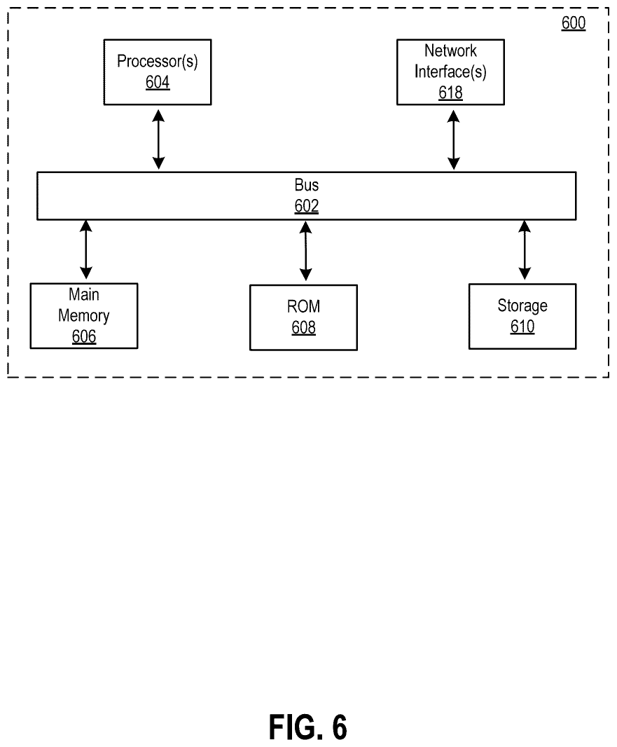

FIG. 6 depicts a block diagram of an example computer system 600 in which various of the embodiments described herein may be implemented. The computer system 600 includes a bus 602 or other communication mechanism for communicating information, one or more hardware processors 604 coupled with bus 602 for processing information. Hardware processor(s) 604 may be, for example, one or more general purpose microprocessors. The computer system 600 may be implemented as one or more of network nodes 10A-10G of FIG. 1.

The computer system 600 also includes a main memory 606, such as a random access memory (RAM), cache and/or other dynamic storage devices, coupled to bus 602 for storing information and instructions to be executed by processor 604. Main memory 606 also may be used for storing temporary variables or other intermediate information during execution of instructions to be executed by processor 604. Such instructions, when stored in storage media accessible to processor 604, render computer system 600 into a special-purpose machine that is customized to perform the operations specified in the instructions. In some examples, main memory 606 or other memory component of computer system 600 may store instructions that, when executed by processor 604, cause the processor 604 to perform one or more of the operations described in connection with FIGS. 2-5.

The computer system 600 further includes a read only memory (ROM) 608 or other static storage device coupled to bus 602 for storing static information and instructions for processor 604. A storage device 610, such as a magnetic disk, optical disk, or USB thumb drive (Flash drive), etc., is provided and coupled to bus 602 for storing information and instructions.

The computing system 600 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 600 may implement the techniques described herein using customized hard-wired logic, one or more ASICs or FPGAs, firmware and/or program logic which in combination with the computer system causes or programs computer system 600 to be a special-purpose machine. According to one example, the techniques herein are performed by computer system 600 in response to processor(s) 604 executing one or more sequences of one or more instructions contained in main memory 606. Such instructions may be read into main memory 606 from another storage medium, such as storage device 610. Execution of the sequences of instructions contained in main memory 606 causes processor(s) 604 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 610. Volatile media includes dynamic memory, such as main memory 606. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 602. Transmission media can also take the form of acoustic or light waves, such as those generated during radio-wave and infra-red data communications.

The computer system 600 also includes a network interface 618 (also referred to as a communication interface) coupled to bus 602. Network interface 618 provides a two-way data communication coupling to one or more network links that are connected to one or more local networks. For example, network interface 618 may be an integrated services digital network (ISDN) card, cable modem, satellite modem, or a modem to provide a data communication connection to a corresponding type of telephone line. As another example, network interface 618 may be a local area network (LAN) card to provide a data communication connection to a compatible LAN (or WAN component to communicated with a WAN). Wireless links may also be implemented. In any such implementation, network interface 618 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through network interface 618, which carry the digital data to and from computer system 600, are example forms of transmission media.

The computer system 600 can send messages and receive data, including program code, through the network(s), network link and network interface 618. In the Internet example, a server might transmit a requested code for an application program through the Internet, the ISP, the local network and the network interface 618.

The received code may be executed by processor 604 as it is received, and/or stored in storage device 610, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 600.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method comprising:
during a first stage of training a machine learning (ML) algorithm:
applying, by a first node, a first differential privacy to one or more local parameters for an ML model to generate one or more first differentially private local parameters, wherein the one or more local parameters are determined based on training a local instance of an ML algorithm using local training data of the first node;
during a second stage of training the ML algorithm:
receiving, by the first node from a second node of the decentralized learning network, one or more differentially private global parameters that are based on merging, by the second node, the one or more first differentially private local parameters with second differentially private local parameters from one or more other nodes;
applying, by the first node, a second differential privacy to one or more updated local parameters for the ML model, the one or more updated local parameters being determined based on training an updated local instance of the ML algorithm using the local training data of the first node, wherein the one or more updated local instance of the ML algorithm is based on the one or more differentially private global parameters; and
transmitting, by the first node to a third node, the one or more updated local parameters,
wherein an amount of the first differential privacy is greater than an amount of the second differential privacy.

2. The method of claim 1, wherein the amount of the second differential privacy is zero.

3. The method of claim 1, wherein the first stage comprises generating an intermediate ML model based on the merging of the one or more first differentially private local parameters with the second differentially private local parameters, wherein the method further comprises:
transitioning from the first stage to the second stage based on a performance of the intermediate ML model satisfying a threshold performance.

4. The method of claim 3, wherein the threshold performance comprises one of: a threshold accuracy of the intermediate ML model, a validation loss of the intermediate ML model, and a measure of change between a performance metric between successive iterations of training, wherein the first stage comprises a plurality of iterations including training a local instance of the ML algorithm.

5. The method of claim 1, wherein applying the first differential privacy to the one or more local parameters comprises perturbing the one or more local parameters by adding noise, randomness or bias to each of the one or more local parameters.

6. The method of claim 1, further comprising:
during the first stage:
transmitting, by the first node, the one or more first differentially private local parameters to the second node,
wherein the second node receives the second differentially private local parameters from the one or more other nodes, wherein the second differentially private local parameters are based on applying at least third differential privacy to local parameters determined by training local instances of the ML algorithm using local training data of the one or more other nodes.

7. The method of claim 1, wherein, during the second stage, the third node generates the ML model pursuant to training instances of the updated instance of the ML algorithm at nodes.

8. The method of claim 1, wherein the first differential privacy is provided as a first value of ε-differential privacy and the second differential privacy is provided as a second value of ε-differential privacy, wherein the first value is less than the second value.

9. The method of claim 1, wherein the first stage of training consumes less computation time than the second stage of training.

10. A network node comprising:
a memory storing instructions; and
a processor operatively connected to the memory and configured to execute the instructions to:
generate a first local parameter by applying a first differential privacy to a local parameter for a machine learning (ML) model, wherein the local parameter is determined based on training a local instance of an ML algorithm using local training data stored in the memory;
update the local instance of the ML algorithm based on a first global parameter received from a first merge leader node, wherein the first global parameter is based, in part, on the first local parameter;
generate a second local parameter by applying a second differential privacy to a local parameter being determined by training the updated local instance of the ML algorithm using the local training data; and
transmit the second local parameter to a second merge leader node,
wherein an amount of the first differential privacy is greater than an amount of the second differential privacy.

11. The network node of claim 10, wherein the first global parameter is based on merging, by the first merge leader node, the first local parameter with one or more local parameters from one or more other nodes.

12. The network node of claim 11, further comprising:
transmitting the first local parameter to the first merge leader node,
wherein the first merge leader node receives the one or more local parameters from the one or more other nodes, wherein the one or more local parameters are based on applying at least third differential privacy to local parameters determined by training local instances of the ML algorithm using local training date of the one or more other nodes.

13. The network node of claim 10, wherein the amount of the second differential privacy is zero.

14. The network node of claim 10, wherein the processor is further configured to execute the instructions to:
generate the second local parameter by applying the second differential privacy is responsive to a performance, based on the first global parameter, satisfying a threshold performance.

15. The network node of claim 10, wherein applying the first differential privacy to the local parameter comprises perturbing the local parameter by adding noise, randomness or bias to the local parameter.

16. The network node of claim 10, wherein the second merge leader node generates the ML model pursuant to training instances of the updated local instance of the ML algorithm at other nodes.

17. The network node of claim 10, wherein the first and second differential privacy is provided as a first and second value of as E-differential privacy.

18. A decentralized learning system comprising:
a plurality of network nodes, each of the plurality of network nodes training an instance of a machine learning (ML) algorithm with data local to each of the plurality of network nodes over a plurality of sequential training stages, each of the plurality of network nodes determining local parameters of the trained instance of the ML algorithm at one or more iterations of training during each of the plurality of sequential training stages, and each of the plurality of network nodes applying, during each training stage of the plurality of sequential training stages, an amount of noise to respective local parameters, wherein an amount of noise applied during one training stage of the plurality of sequential training stages is less than an amount of noise applied during a sequentially preceding training stage; and
a leader node merging each of the local parameters with one another, sharing the merged parameters with each of the plurality of network nodes, and generating an ML model based on re-training of the instance of the ML algorithm at each of the plurality of network nodes in accordance with the merged parameters.

19. The decentralized learning system of claim 18, wherein the amount of noise applied during a final training stage of the plurality of sequential training stages is set to zero.

20. The decentralized learning system of claim 18, wherein the plurality of network nodes transition from one training stage of the plurality of sequential training to a next training stage of the plurality of sequential training based on a performance of the ML model satisfying a stopping criterion.
